(19) United States
(12) Patent Application Publication
(10) Pub. No.: US 2026/0257159 A1
(43) Pub. Date: Sep. 3, 2026

(54) COMPOSITE MATERIALS

(71) Applicant: DelStar Technologies, Inc., Alpharetta, GA (US)

(72) Inventors: Thomas Adjei, Slingerlands, NY (US); Rama Jude, Slingerlands, NY (US); John Cox, Middletown, DE (US); Andrew G. Platt, Reading, DE (US)

(21) Appl. No.: 19/068,511

(22) Filed: Mar. 3, 2025

(51) Int. Cl. B01D 39/16

(52) U.S. Cl. CPC B01D 39/1623; B01D 2239/0622; B01D 2239/0654; B01D 2239/1208; B01D 2239/1216; B01D 2239/1258; B01D 2239/1291

(57) ABSTRACT

The present disclosure provides composite materials comprising a layer, sheet or web comprising wet-laid fibers and melt blown fibers. The wet-laid and melt blown fibers have basis weights and pore size distributions selected to optimize certain performance features of the composite material. In various embodiments, the ratio between the maximum pore size and the mean flow pore size or the pore size distribution (PSD) is less than about 2.5, or less than about 2.0. In embodiments wherein the composite material is used as a filter media, the filter media has an improved air permeability, contaminant removal efficiency and dust holding capacity.

### CROSS-REFERENCE TO RELATED APPLICATIONS

This application claims the benefit of U.S. Provisional Application Ser. No. 63/560,832, filed Mar. 4, 2024, the complete disclosure of which is incorporated herein by reference for all purposes.

### TECHNICAL FIELD

This description generally relates to composite materials, and more particularly to composite materials configured for use as filter media.

### BACKGROUND

Nonwoven fibers are used in a wide variety of applications, such as filtration media, insulating materials, medical applications, such as face masks and surgical gowns, battery separators, hygiene care applications, clothing, food packaging, cosmetics, and many others. One particular application for nonwoven fibers is in liquid filtration. Liquid filtration is the process of removing solid particles, impurities, and contaminants that are suspended in a fluid stream. It generally involves the flow of the process liquid (in the form of slurries and suspensions) through a permeable filter medium and the blocking and retention of the captured solids.

There are two main types of liquid filtration: surface and depth. The filtration method is primarily distinguished from the structure of its filter medium. Depth filtration is used to retain the particles throughout the depth of the filter medium. Depth filters typically use a thick, multi-layered filter medium that increases its density towards the direction of the flow. The larger particles are retained on the surface of the filter, which has the least media density, and the particle size progressively becomes finer across the depth of the filter. The high pore volume of the filter presents a tortuous and difficult flow path for the solid to pass through. The greater resistance it offers effectively blocks the solid particles from combining into the filtrate.

Depth filters are typically used when the processed liquid contains a wide range of particle sizes. Depth filters can filter particles smaller than the mean pore size and they have a higher particle holding capacity and can trap a large volume of solids before they become clogged. They can remove gelatinous particles from the process liquid. Lastly, they have a long service life and are less frequently replaced but they are typically single-use products.

When identifying the required flow rate, the key considerations are pore size and required liquid throughput. The pore size of the membrane is selected based on the intended performance of the final device. The pore rating dictates the functional attributes of the membrane, including flow rate and throughput. For example, the use of membranes with smaller pore sizes will generally increase the efficiency of the filter in capturing contaminants. On the other hand, these smaller pore sizes will generally result in lower flow rates and reduced throughput compared to membranes with larger pore sizes.

### SUMMARY

Composite materials and methods for manufacturing the composite materials are provided herein. The composite materials may be configured for use in a variety of applications, including but not limited to, liquid filters.

In one aspect, a composite material for use as a filter media comprises a layer, sheet or web comprising wet-laid fibers and melt blown fibers. The layer has a ratio of a maximum pore size to a mean flow pore size (i.e., pore size distribution) of about 2.5 or less. The substantially uniform pore size distribution improves certain performance features of the filter media, such as lifespan, efficiency, and capacity, without substantially compromising air permeability and/or flow rate through the material.

In various embodiments, the composite material has a maximum pore size of about 30 microns or less. In certain embodiments, the maximum pore size is about 20 microns or less, or about 13 microns or less.

In various embodiments, the composite material has a mean flow pore size of about 15 microns or less. In certain embodiments, the mean flow pore size is about 10 microns or less, or about 7 microns or less.

In various embodiments, the pore size distribution (i.e., the ratio of the maximum pore size to the mean flow pore size) of about 2.0 or less, or about 1.5 or less.

In various embodiments, the wet-laid fibers have a basis weight of about 20 gsm to about 300 gsm, or about 50 gsm to about 200 gsm, or about 100 gsm to about 200 gsm. In one embodiment, the wet-laid fibers have a basis weight of about at least about 100 gsm. In another embodiment, the wet-laid fibers have a basis weight of about at least about 200 gsm.

In various embodiments, the melt blown fibers have a basis weight of about 20 gsm to about 300 gsm, or about 20 gsm to about 200 gsm, or about 20 gsm to about 100 gsm. In an exemplary embodiment, the melt blown fibers have a basis weight of about 20 gsm, or about 40 gsm or about 100 gsm.

The wet laid and melt blown fibers may be woven, interlaid, layered, fused, entangled, ultrasonically bonded, or bonded together in other manners known to those of skill in the art. In an exemplary embodiment, the layers are ultrasonically bonded together.

In various embodiments, the composite material has a dust holding capacity of at least about 24 mg/in². In certain embodiments, the dust holding capacity is greater than about 60 mg/in² or greater than about 100 mg/in².

In various embodiments, the composite material has an improved efficiency at capturing contaminants, particularly contaminants contained in a liquid. In an exemplary embodiment, the composite material has at least a 95% or greater efficiency at capturing particles having a maximum dimension of 17 microns or greater, or about 15 microns or greater, or about 10 microns or greater. In various embodiments, the material has an efficiency at capturing particles having a dimension of about 25 microns of at least about 95.4%, or at least about 96.7% or at least about 98.3%.

Suitable materials for the wet-laid fibers include, but are not limited to, polypropylene, polyesters (PET), PEN polyester, PCT polyester, polypropylene, PBT polyester, co-polyamides, polyethylene, high density polyethylene (“HDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof.

In an exemplary embodiment, the wet-laid fibers are synthetic fibers and at least some of the fibers in the second layer comprise polyester. In certain embodiments, the wet-laid fibers are 100% polyester.

In various embodiments, the melt blown fibers include, but are not limited to, any polymer with thermoplastic behavior, such as polypropylene, polystyrene, polyesters, polyurethane, polyamides (nylons), polyethylene, polycarbonate, and combinations thereof. In an exemplary embodiment, the melt blown fibers comprise polyester.

In various embodiments, the wet-laid fibers are produced from a process in which the fibers are dispersed in a liquid, such as water or foam, and deposited onto a wire, drying matt, or filter on which the liquid is drained or removed to form a web that is either dried or thermally bonded. In some embodiments, the wet-laid fibers comprise foam-laid fibers formed from a dispersion of such fibers in a foamed liquid.

In various embodiments, the melt blown fibers are produced by melting a polymer, extruding the polymer through orifices or nozzles, and then blowing them into ultrafine fibers with hot, high-velocity air. The ultrafine fibers are collected on a rotary drum or a forming belt with a vacuum underneath the surface to form a nonwoven web.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. In some embodiments, the fibers may have a linear density of about 1 denier to about 15 deniers, or at least about 8 denier, or at least about 10 denier or at least about 13 denier.

In certain embodiments, the composite material may further include a support structure, which may comprise a reticular support structure, such as a netting, matting, grid, mesh, or the like. In these embodiments, the wet-laid and melt blown fibers may be ultrasonically bonded to the strands of the reticular support structure (e.g., a netting) at a plurality of attachment points. Ultrasonically bonding the fibers to the netting is more convenient and cost effective than adhesives or other methods of laminating the fibers to the netting.

In another aspect, a product is provided comprising the composite material(s) described above. The product may comprise, for example, a filter media for a liquid filter, or a liquid filter, such as an oil filter, a gas filter, a fuel filter, a hydraulic filter, a chemical filter, or the like.

In another aspect, a filter media comprises a first layer comprising wet-laid fibers and melt blown fibers and a support structure in contact with the first layer.

In various embodiments, the filter media has a maximum pore size of about 30 microns or less. In certain embodiments, the maximum pore size is about 20 microns or less, or about 13 microns or less.

In various embodiments, the filter media has a mean flow pore size of about 15 microns or less. In certain embodiments, the mean flow pore size is about 10 microns or less, or about 7 microns or less.

In various embodiments, the filter media has a reduced pore size distribution, i.e., the ratio of the maximum pore size to the mean flow pores size is about 2.5 or less, or about 2 or less. In certain embodiments, this ratio is less than 1.5.

In various embodiments, the support structure is a reticular support structure, such as a netting, matting, grid, mesh, or the like. In these embodiments, the wet-laid and melt blown fibers may be ultrasonically bonded to the strands of the reticular support structure (e.g., a netting) at a plurality of attachment points.

In various embodiments, the strands of the netting have a basis weight of at least about 80 gsm, or at least about 100 gsm, or at least about 110 gsm. In some embodiments, the stands of the netting have an average thickness of at least about 0.20 inches or at least about 0.025 inches. This configuration increases the surface area of the strands, thereby providing a stronger ultrasonic bond between the netting and the fibers in the first layer.

Suitable materials for the netting include, but are not limited to, high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof. In an exemplary embodiment, the netting comprises HDPE, PP, or combinations thereof.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 illustrates a composite material comprising wet-laid fibers and melt blown fibers;

FIG. 2 is a cross-sectional view of a composite material comprising a first layer of melt blown and wet-laid fibers and a layer of netting;

FIG. 3 is an exploded view of the netting of FIG. 2;

FIG. 4 illustrates a liquid cartridge filter;

FIG. 5 illustrates a liquid bag filter;

FIG. 6 illustrates a pleated filter cartridge; and

FIG. 7 illustrates a membrane filter cartridge.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Composite materials are provided that are configured for use in a variety of applications, such filter media for liquid filters. The filter media may be used in a variety of industries, such as pulp and paper, food and beverage, steel production, industrial process fluids, municipal, automotive, power generation, semiconductor manufacturing, mining/construction, petroleum/chemical refining, medical/pharmaceutical and general manufacturing.

For example, various embodiments include fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include semiconductor processing filters to filter nano-sized particles and harmful contaminants during logic and chip fabrication, including microfiltration filters with hydrophobic or hydrophilic membranes, chemical filters, CMP filters, lithography filters, process gas filters and purifiers, chemical mechanical polishing filters, electrolyte plating, wastewater filters, wet etch and clean filters, PFOA filters and the like.

For example, various embodiments include filters for the food and beverage industry for removing solid and/or liquid contaminants, such as filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter certrifuges or filter presses for de-watering separated grains in, for example, a distillery or brewery.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

For example, various embodiments include battery separators that serve as a mechanical barrier between the electrodes to prevent shorting while allowing for ionic transport through the electrolyte in the pores. For example, various embodiments include an alkaline battery separator, including, but not limited to, zinc-manganese dioxide (Zn/MnO₂), nickel-cadmium (Ni—Cd), and nickel-hydrogen (Ni—H₂) batteries. The battery separators may include a substrate comprising blends of polyvinyl alcohol (PVA) fibers and cellulose or cellulose derivatives such as rayon or lyocell.

While the following description is primarily presented with respect to filter media and liquid filters, the devices and methods disclosed herein may be readily adapted for use in a variety of other applications. For example, the filter media disclosed herein may be useful in household cleaning products, roofing and flooring products, automobile upholstery and headliners, reusable bags, wallcoverings, filtration devices, insulation, and the like. In addition, the individual nanoparticles that are isolated and generated in the processes described herein may be utilized in various coatings, composites and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

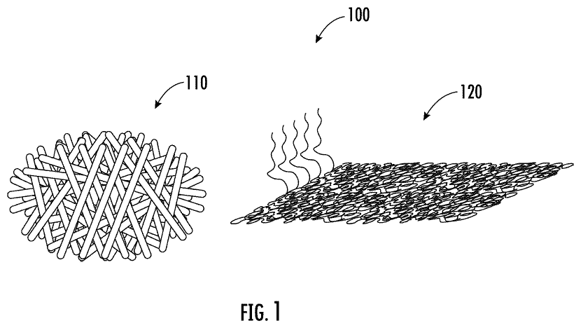

Referring now to FIG. 1, a composite material 100 comprises a layer of wet-laid fibers 110 and melt blown fibers 120. The wet laid and melt blown fibers 110, 120 may be woven, interlaid, layered, fused, entangled, ultrasonically bonded, or bonded together in other manners known to those of skill in the art. The fibers 110, 120 may form a layer, sheet or web structure bonded together by entangling fibers or filaments mechanically, thermally, or chemically. In an exemplary embodiment, the fibers 110, 120 are ultrasonically bonded together.

Wet-laid fibers as defined herein are fibers produced from a process in which the fibers are dispersed in a liquid, such as water or foam, and deposited onto a frame or forming wire, drying matt, or filter on which the liquid is drained or removed to form a web that is either dried or thermally bonded. A wet laid process typically involves providing staple or discrete fibers of about 2 mm to about 15 mm in length, preferably about 4 mm to about 8 mm. In some embodiments, the fibers may be mixed with viscose or wood pulp.

In an exemplary embodiment, the wet laid fibers 110 are foam-laid fibers. Foam-laid fibers as defined herein are fibers formed from a dispersion of fibers in a foamed liquid. A pulp or fiber furnish is first prepared in a pulper, followed by dewatering, mixing with a foam or foamable liquid containing a surfactant and water. The fibers are dispersed in the foam and the formed fiber-foam is deposited on a wire and the main portion of the liquid, which is essentially in the form of foam, is removed by a suction. Surfactants may be of any suitable type, such as anionic, cationic, non-ionic, and amphoteric surfactants. Additionally, wet-strengtheners, binders, creping chemicals etc. may be used. Surfactants used in the foaming process are generally regarded as having a negative influence on both the dry and wet tensile strength of a paper web.

Foam forming keeps water as a gluing element but uses the bubble structure and rheological properties of wet foam to keep the fibers apart. Thus, the flow of foam during forming can be laminar providing control over the distribution and orientation of the fibers. Moreover, foam stability affects final material density, and the average pore size can be tailored by adjusting the bubble size.

The melt blown fibers 120 are produced by melting a polymer, extruding the polymer through orifices or nozzles, and then blowing them into ultrafine fibers with hot, high-velocity air. The ultrafine fibers are collected on a rotary drum or a forming belt with a vacuum underneath the surface to form a nonwoven web. Suitable melt blown fibers include any polymer with thermoplastic behavior, such as polypropylene, polystyrene, polyesters, polyurethane, polyamides (nylons), polyethylene, polycarbonate, and combinations thereof.

The basis weight of the fibers is selected to optimize the bonding and increase the overall strength of the material 100. In embodiments wherein material 100 is used as a filter media, the filter has a longer lifespan, efficiency, and capacity, without compromising other performance factors, such as air permeability and through-put.

In various embodiments, the wet-laid fibers have a basis weight of about 20 gsm to about 300 gsm, or about 50 gsm to about 200 gsm, or about 100 gsm to about 200 gsm. In one embodiment, the wet-laid fibers have a basis weight of about at least about 100 gsm. In another embodiment, the wet-laid fibers have a basis weight of about at least about 200 gsm.

In various embodiments, the melt blown fibers have a basis weight of about 20 gsm to about 300 gsm, or about 20 gsm to about 200 gsm, or about 20 gsm to about 100 gsm. In an exemplary embodiment, the melt blown fibers have a basis weight of about 20 gsm, or about 40 gsm or about 100 gsm.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. For gas filters, such as pleated or unpleated air filters, the fibers may have a linear density in the range of about 1 denier to about 10 deniers. The composite material may comprise fibers with the same or different linear densities. In some embodiments, the wet-laid fibers may have a linear density of about 1 denier to about 15 deniers, or at least about 8 denier, or at least about 10 denier or at least about 13 denier.

The composite material 100 may have a thickness suitable for the particular application. In certain embodiments, the composite material 100 has a thickness of about 0.0508 mm to about 01.016 mm, preferably about 0.127 mm to about 0.635 mm.

The fibers may have many shapes in cross-section, including without limitation, circular, kidney bean, dog bone, trilobal, barbell, bowtie, star, Y-shaped, and others. With different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

The fibers 110, 120 may be artificial or natural. Suitable materials for the fibers include, but are not limited to, polypropylene, polyesters (PET), PEN polyester, PCT polyester, polypropylene, PBT polyester, co-polyamides, polyethylene, high density polyethylene (“IHDPE”), LLDPE, cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof. Other conventional fiber materials are contemplated.

In an exemplary embodiment, at least some of the wet-laid 110 comprise polyester. In certain embodiments, the fibers are 100% polyester.

In an exemplary embodiment, at least some of the melt blown fibers 120 comprise polyester.

In some embodiments, the fibers may include bicomponent fibers that are thermally splitable to reduce the fiber size of at least some components of the fibers within the filter media. This reduced fiber size increases the specific surface are thus increases the overall efficiency of such filters at capturing contaminants, particularly those contaminants having a size range of about 0.1 to about 1 micron (i.e., E1 particles), without compromising other important characteristics of the filters, such as pressure drop and air permeability. The bicomponent fibers may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof.

The fibers may be staple fibers or continuous fibers. The fibers may be naked (e.g., zero spin finish) or the fibers may include a spin finish. The spin finish may include but is not limited to, lubricants, emulsifiers, antistats, anti-microbial agents, cohesive agents, and wetting agents. Other organic liquids, such as alcohols or blends of organic liquids may be added to the spin finish. The spin finish may be applied, for example, during carding of the fibers, during the melt spinning operation, or operation of drawing, crimping, and cutting of the fibers.

In various embodiments, the composite material has a maximum pore size of about 30 microns or less. In certain embodiments, the maximum pore size is about 20 microns or less, or about 13 microns or less.

In various embodiments, the composite material has a mean flow pore size of about 15 microns or less. In certain embodiments, the mean flow pore size is about 10 microns or less, or about 7 microns or less.

In various embodiments, the composite material has a reduced pore size distribution, i.e., the ratio of the maximum pore size to the mean flow pores size is about 2.5 or less, or about 2 or less. In certain embodiments, this ratio is less than 1.5.

In an exemplary embodiment, the composite material has a porosity value of about 85% to about 97%, or about 90% to about 95%. Porosity value is defined as the nonsolid or pore-volume fraction of the total volume of the material.

In various embodiments, the composite material has a dust holding capacity of at least about 24 mg/in². In certain embodiments, the dust holding capacity is greater than about 60 mg/in² or greater than about 100 mg/in².

In various embodiments, the composite material has an improved efficiency at capturing contaminants. In an exemplary embodiment, the composite material has a 95% or greater efficiency at capturing particles having a maximum dimension of 17 microns or greater, or about 15 microns or greater, or about 10 microns or greater. In various embodiments, the material has an efficiency at capturing particles having a maximum dimension of about 25 microns of at least about 95.4%, or at least about 96.7% or at least about 98.3%.

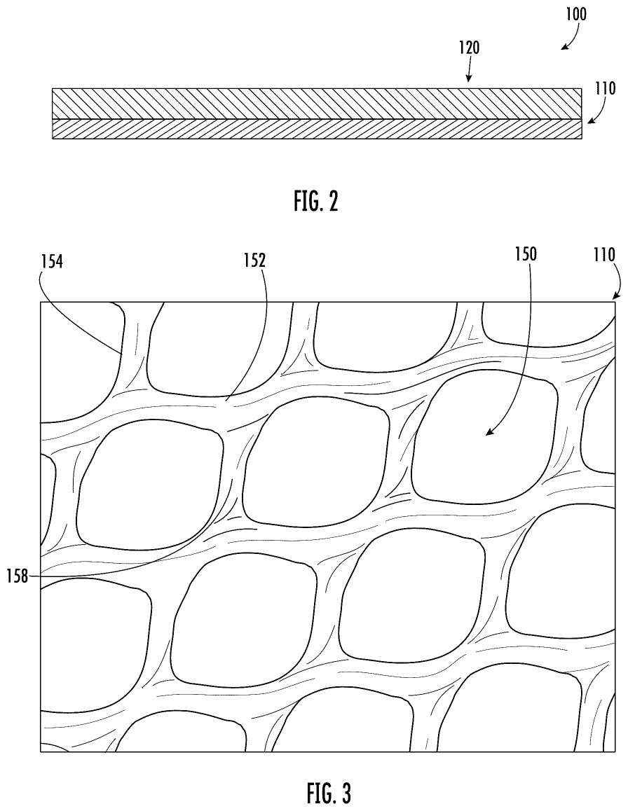

In certain embodiments, a composite material 140 may further include one or more support structure(s) (not shown), which may include a reticular support structure 160, such as a netting, matting, grid, mesh, or the like. In these embodiments (shown in FIGS. 2 and 3), the wet-laid and melt blown fibers (shown formed in one layer 150) may be ultrasonically bonded to the strands of the reticular support structure 160 (e.g., a netting) at a plurality of attachment points. Ultrasonically bonding the fibers to the netting 160 is more convenient and cost effective than adhesives or other methods of laminating the fibers to the netting.

For example, wet laid and melt blown fibers 150 and the netting 160 may be fed into an ultrasonic bonding device that applies high frequency ultrasonic vibrations to melt and/or bond the strands of netting to the fibers 150 at a plurality of attachment points on the netting. To affect this bonding, the fibers 150 and the netting 160 are transported through a gap between an ultrasonic vibrating unit, such as a horn, and a mating tool of an ultrasonic device, such as an anvil or rotating drum. The ultrasonic device applies little to no pressure to the fibers or the netting. This allows the thickness or loft of the fibers to be substantially maintained as the fibers are bonded to the netting.

Suitable materials for the netting include, but are not limited to, high density polyethylene (HDPE), low density polyethylene, polyethylene, polypropylene (PP), metallocene PP, polylactic acid (PLA). thermoplastic polymers, nylon, polybutylene terephthalate (PBT), thermoplastic elastomers (TBE), polyphenylene sulfide (PPS), polyvinylidene fluoride (PVDF) and combinations thereof. In an exemplary embodiment, the netting comprises HDPE, PP, and combinations thereof.

The netting may be formed from any suitable method such as extrusion, co-extrusion, bi-component, and elastomeric nettings. In an exemplary embodiment, the netting is formed from a mono-extrusion process. Generally, suitable methods for making the extruded netting includes extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers.

As shown in FIG. 3, apertures 150 may be formed from a first series of strands 152 extending in one direction and a second series of strands 154 extending in a generally crosswise or transverse direction. The first and second sets of strands 152, 154 are extruded polymeric elongate members which cross and intersect during extrusion to form the net-like structure. The strands could also be formed of extruded strands that are knitted together rather than crossed during extrusion. In some embodiments, the strands are made of the same material. In other embodiments, the first set of strands 152 are made of a different material than the second set of strands 154.

The strands may be formed at an angle of about 10 to about 90 degrees, or about 50 to about 80 degrees, or about 60 degrees. In an exemplary embodiment, the apertures formed by the strands are symmetrical although it will be recognized that the apertures may be non-symmetrical in certain embodiments. The strand density is preferably less than about 100 strands per inch, or less than about 50 strands per inch, or less than about 44 strands per inch.

The strands 152, 154 preferably have a basis weight of at least about 80 gsm, or at least about 100 gsm, or at least about 110 gsm. The average thickness 158 of the strands 152, 154 is preferably about 0.006 inches to about 0.0400 inches, or about 0.02 inches to about 0.03 inches, or about 0.025 to about 0.026 inches. In an exemplary embodiment, the strands have an average thickness of about 0.0254 inches.

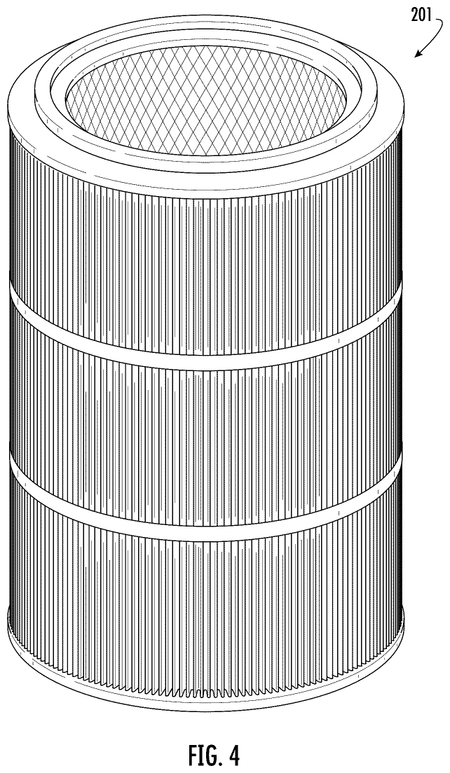

FIG. 4 illustrates a representative liquid filter 201 produced with various embodiments of the composite materials described herein. The composite material is rolled into a cylinder, cone, or other suitable shape and may be used in applications, such as gas turbine and compressor air intake filters, panel filters and the like. A cartridge is a tubular filter medium that is encased inside a housing. The direction of flow in a cartridge filter is typically from outside to the insides of the cartridge. Cartridges are usually made from synthetic or natural fibers and small metal wires. A core, made of stainless or tin-plated steel or polypropylene, is present on the axis of the tubular cartridge to support the media material. A purer filtrate is collected at its core.

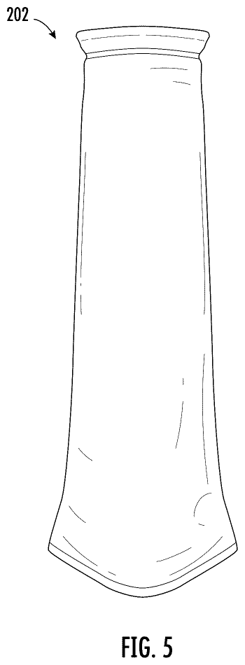

FIG. 5 illustrates a representative bag filter 202 produced with various embodiments of the composite materials described herein. Bag filters are one of the most popular filtration equipment. In this equipment, the process liquid passes through a permeable bag perforated with microscopic holes which act as the filter medium. The solid particles larger than the holes are entrapped and accumulated inside the bag. Its end has a sealing ring, usually made from stainless steel or plastic, to secure the bag inside the filtration vessel.

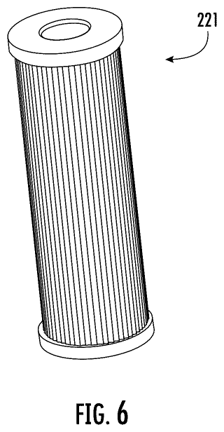

FIG. 6 illustrates a representative pleated filter cartridge 212 produced with various embodiments of the composite materials described herein. Filter cartridge 112 is particularly useful in surface filtration and may be constructed by pleating the media bonded at its ends to provide a larger filtration area for a minimal volume.

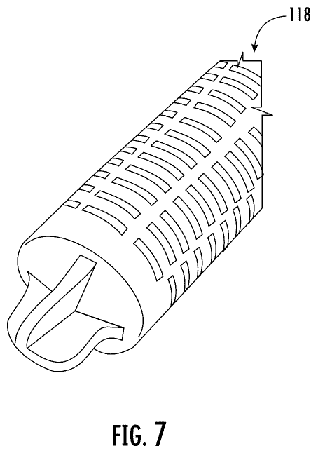

FIG. 7 illustrates a membrane filter cartridge 218 produced with various embodiments of the composite materials described herein. Filter cartridge 118 is particularly useful in the food and beverage, pharmaceutical, UPW, and semiconductor industries. Filter cartridge 118 may comprise PTFE, PES, PVDF and/or nylon and may have a pleated filter construction. The folded structure offers each pleated membrane filter cartridge a large filter area and high dirt holding capacity, hence efficiently increasing the service tirne.

Other types of liquid filters that may be developed with the materials disclosed herein include conical filter cartridges, spun-bonded cartridges, square-end cap filter cartridges, activated carbon filter cartridges, reverse osmosis membrane cartridges, alkaline filter cartridges, battery separators, ultraviolet filter cartridges, pocket filters, V-bank compact filters, panel filters, flat cell filters, pleated or unpleated bag cartridge filters, clean-in-place (CIP) filters and the like.

### EXAMPLES

The applicant manufactured and tested several different composite materials for use as filter medias that comprised 100% polyester wet-laid fibers and melt blown fibers. The wet-laid fibers had a basis weight of about 100 gsm. The samples further included: (1) melt blown fibers having a basis weight of 20 gsm and comprising polyester (Sample 1); (2) melt blown fibers having a basis weight of 40 gsm and comprising polyester (Sample 2); (3) melt blown fibers having a basis weight of 40 gsm and comprising polyester (Sample 3); (4) melt blown fibers having a basis weight of 100 gsm and comprising polyester (Sample 4); (5) melt blown fibers having a basis weight of 40 gsm and comprising polyester (Sample 5); and (6) melt blown fibers having a basis weight of 100 gsm and comprising polyester (Sample 6).

Applicant tested the above composite materials for dust holding capacity (in grams and mg/in²), efficiency at capturing contaminants (95% efficiency in microns and percentage efficiency at 25 microns), mean and maximum flow pore sizes (in microns), bubble point (in H²O), air permeability (in cfm/ft²/min) and porosity (%). The capacity was tested under J905 standard, and the efficiency was tested under J1985 standard. Porosity value is defined as the nonsolid or pore-volume fraction of the total volume of the material. The result of this testing is shown below in TABLES 1 and 2.

TABLE 1

| | Capacity | Capacity | Efficiency | % Efficiency (@ |
|---|---|---|---|---|
| Sample | (g) | (mg/in²⁾ | (microns) | 25 microns) |
| Sample 1 | 0.97 | 48.5 | 16-17 | 95.4-96.5 |
| Sample 2 | 1.27 | 63.5 | 15 | 97.53 |
| Sample 3 | 1.68 | 84 | 14-15 | 95.7-97.6 |
| Sample 4 | 2.27 | 113.5 | 15 | 96.76 |
| Sample 5 | 0.48 | 24 | 11 | 96.7 |
| Sample 6 | 0.58 | 29 | 10 | 98.3 |

TABLE 2

| | Mean Flow | Max Flow | | | |
|---|---|---|---|---|---|
| | Pore | Pore | Bubble | | |
| | Diameter | Diameter | Point | Air Perm | Porosity |
| Sample | (microns) | (microns) | (H²O) | (cfm/ft²/min) | (%) |
| Sample 1 | 13.7 | 23.7 | 9.7 | 66 | 94.49 |
| Sample 2 | 13.4 | 18.47 | 12.5 | 42 | 94.09 |
| Sample 3 | 11.6 | 17.7 | 13 | 45 | 94.09 |
| Sample 4 | 14.58 | 28.4 | 8 | 30 | 92.92 |
| Sample 5 | 6.6 | 12.8 | 17.87 | 8 | 93.41 |
| Sample 6 | 4.77 | 11.48 | 20 | 24 | 91.79 |

The last two samples (Sample 5 and 6) were calendared. The first four samples were not calendared. It should be noted that the calendaring step significantly decreased the maximum pore sizes and the mean flow pore sizes. For example, Sample 5 had a mean flow pore size of about 6.6 microns and a maximum pore size of about 12.8 microns. Sample 6 had a mean flow pore size of about 4.77 microns and a maximum pore size of about 11.48 microns. The pore size distribution (PSD) or the ratio of the maximum pore size to the mean flow pore size for Sample 5 was less than 2 and the PSD for sample 6 was less than 2.5. The PSD for samples 1-4 was less than 2 for all samples. Reducing the PSD creates a more uniform structure and a controlled porosity that increases the efficiency of the material in capturing particles.

It should also be noted that the efficiency at capturing at contaminants at least 95% of the contaminants was less than 17 for all Samples. Thus, all samples captured at least 95% of contaminants that were 17 microns or higher. In addition, all Samples captured over 95% of 25 microns. The calendared samples 5 and 6 were particularly effective with Sample 5 capturing at least 95% of contaminants that were 11 microns or higher and Sample 6 capturing at least 95% of contaminants that were 10 microns or higher. The porosity of Samples 1-6 was greater than 91%, or at least about 91.79%.

The applicant also manufactured and tested several different composite materials for use as filter medias that comprised 100% polyester wet-laid fibers and melt blown fibers. The wet-laid fibers had a basis weight of about 200 gsm. The samples further included: (1) melt blown fibers having a basis weight of 20 gsm and comprising polyester (Sample 7); (2) melt blown fibers having a basis weight of 40 gsm and comprising polyester (Sample 8); (3) melt blown fibers having a basis weight of 40 gsm and comprising polyester (Sample 9); (4) melt blown fibers having a basis weight of 100 gsm and comprising polyester (Sample 10); (5) melt blown fibers having a basis weight of 40 gsm and comprising polyester (Sample 11); and (6) melt blown fibers having a basis weight of 100 gsm and comprising polyester (Sample 12).

Applicant tested the above composite materials for dust holding capacity (in grams and mg/in²), efficiency at capturing contaminants (95% efficiency in microns and percentage efficiency at 25 microns), mean and maximum flow pore sizes (in microns), bubble point (in H²O), air permeability (in cfm/ft²/min) and porosity (%). The capacity was tested under J905 standard, and the efficiency was tested under J1985 standard. Porosity value is defined as the nonsolid or pore-volume fraction of the total volume of the material. The result of this testing is shown below in TABLES 3 and 4.

TABLE 1

| | Capacity | Capacity | Efficiency | % Efficiency (@ |
|---|---|---|---|---|
| Sample | (g) | (mg/in²⁾ | (microns) | 25 microns) |
| Sample 7 | 1.24 | 62.0 | 17 | 96.58 |
| Sample 8 | 1.31 | 65.5 | 15 | 97.03 |
| Sample 9 | 1.4 | 70 | 14 | 95.64 |
| Sample 10 | 2.8 | 140 | 15 | 96.42 |
| Sample 11 | 0.75 | 37.5 | 13 | 97.11 |
| Sample 12 | 0.31 | 15.5 | 9-10 | 95.6-97.8 |

TABLE 4

| | Mean Flow | Max Flow | | | |
|---|---|---|---|---|---|
| | Pore | Pore | Bubble | | |
| | Diameter | Diameter | Point | Air Perm | Porosity |
| Sample | (microns) | (microns) | (H²O) | (cfm/ft²/min) | (%) |
| Sample 7 | 14.42 | 23.19 | 9.96 | 45.62 | 93.14 |
| Sample 8 | 11.89 | 20.32 | 11.36 | 33.3 | 92.94 |
| Sample 9 | 13 | 21.33 | 10.82 | 35.36 | 92.94 |
| Sample 10 | 14.75 | 22.5 | 10.26 | 25.9 | 92.22 |
| Sample 11 | 7.13 | 17.1 | 13.5 | 22.48 | 92.39 |
| Sample 12 | 5.46 | 12.12 | 19.05 | 7.83 | 90.9 |

The last two samples (Sample 11 and 12) were calendared. The first four samples (Samples 7-10) were not calendared. It should be noted that the calendaring step significantly decreased the maximum pore sizes and the mean flow pore sizes. For example, Sample 11 had a mean flow pore size of about 7.13 microns and a maximum pore size of about 17.1 microns. Sample 6 had a mean flow pore size of about 5.46 microns and a maximum pore size of about 12.12 microns. The pore size distribution (PSD) or the ratio of the maximum pore size to the mean flow pore size for Samples 11 and 12 were less than 2.5. The PSD for samples 7-10 was less than 2 for all samples. Reducing the PSD creates a more uniform structure and a controlled porosity that increases the efficiency of the material in capturing particles.

It should also be noted that the efficiency at capturing at contaminants at least 95% of the contaminants was less than 17 for all Samples. Thus, all samples captured at least 95% of contaminants that were 17 microns or higher. In addition, all Samples captured over 95% of 25 microns. The calendared samples 11 and 12 were particularly effective with Sample 11 capturing at least 95% of contaminants that were 13 microns or higher and Sample 12 capturing at least 95% of contaminants that were 9 microns or higher. The porosity of Samples 7-12 was greater than 90%, or at least about 90.9%.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a composite material for use as a filter media. The composite material comprises a layer of wet-laid fibers and melt blown fibers. The layer has a ratio of a maximum pore size to a mean flow pore size of about 2.5 or less.

A second embodiment is the first embodiment, wherein the maximum pore size is less than about 30 microns.

A third embodiment is any combination of the first 2 embodiments, wherein the mean flow pore size is less than about 15 microns.

A 4^{th} embodiment is any combination of the first 3 embodiments, wherein the material has a ratio of a maximum pore size to a mean flow pore size of about 2.0 or less.

A 5^{th} embodiment is any combination of the first 4 embodiments, wherein the material has a ratio of a maximum pore size to a mean flow pore size of about 1.5 or less.

A 6^{th} embodiment is any combination of the first 5 embodiments, wherein the material has a bubble point of less than or equal to about 20 in/H²O.

A 7^{th} embodiment is any combination of the first 6 embodiments, wherein the material has a dust holding capacity of at least about 24 mg/in².

An 8^{th} embodiment is any combination of the first 7 embodiments, wherein the material has an efficiency at capturing particles having a maximum dimension of about 25 microns of at least about 95.4%.

A 9^{th} embodiment is any combination of the first 8 embodiments, wherein the material has a 95% or greater efficiency at capturing particles having a maximum dimension of 17 microns or greater.

A 10^{th} embodiment is any combination of the first 9 embodiments, wherein the material has an air permeability of about 66 cfm/ft²/min or less.

An 11^{th} embodiment is any combination of the first 10 embodiments, wherein the wet-laid fibers have a basis weight of at least about 50 gsm.

A 12^{th} embodiment is any combination of the first 11 embodiments, wherein the basis weight is about 50 gsm to about 200 gsm.

A 13^{th} embodiment is any combination of the first 12 embodiments, wherein the basis weight is about 100 gsm.

A 14^{th} embodiment is any combination of the first 13 embodiments, wherein the wet-laid fibers are foam-laid fibers.

A 15^{th} embodiment is any combination of the first 14 embodiments, wherein the wet-laid fibers comprise a material selected from the group consisting of polypropylene, polyester, polypropylene, co-polyamides, polyethylene, polycarbonate, polyacrylate, polyacrylonitrile, polystyrene, styrene maleic anhydride, propylene, polyimide, polyether ketone, cellulose ester, nylon and polyamide, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 16^{th} embodiment is any combination of the first 15 embodiments, wherein the wet-laid fibers comprise polyester.

A 17^{th} embodiment is any combination of the first 16 embodiments, wherein the melt blown fibers comprise a material selected from the group consisting of polyester.

An 18^{th} embodiment is any combination of the first 17 embodiments, further comprising a support structure in contact with at least one of the first and second layers.

A 19^{th} embodiment is any combination of the first 18 embodiments, wherein the support structure comprises a netting comprising strands.

A 20^{th} embodiment is any combination of the first 19 embodiments, wherein the strands have a basis weight of at least about 100 gsm.

A 21^{st} embodiment is any combination of the first 20 embodiments, wherein the basis weight is at least about 110 gsm.

A 22^{nd} embodiment is any combination of the first 21 embodiments, wherein the support structure is ultrasonically bonded to the first and second layers at a plurality of attachment points.

A 23^{rd} embodiment is any combination of the first 22 embodiments, wherein the netting comprises a material selected from the group consisting of high-density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

A 24^{th} embodiment is any combination of the first 23 embodiments, wherein the porosity of the layer is about 90% to about 95%.

In another aspect, a filter media is provided comprising the composite material of any combination of the first 24 embodiments.

In another aspect, a liquid filter media is provided comprising the composite material of any combination of the first 24 embodiments.

In another aspect, an oil filter is provided comprising the composite material of any combination of the first 24 embodiments.

In another aspect, a gas filter is provided comprising the composite material of any combination of the first 24 embodiments.

In another aspect, a fuel filter is provided comprising the composite material of any combination of the first 24 embodiments.

In another aspect, a hydraulic filter is provided comprising the composite material of any combination of the first 24 embodiments.

In another aspect, a chemical filter is provided comprising the composite material of any combination of the first 24 embodiments.

In another aspect, a first embodiment is a fuel filter comprising a first layer comprising wet-laid fibers and melt blown fibers and a support structure in contact with the first layer.

A second embodiment is the first embodiment, wherein the filter media has a maximum pore size of less than about 30 microns.

A third embodiment is any combination of the first 2 embodiments, wherein the filter media has a mean flow pore size of less than about 15 microns.

A 4^{th} embodiment is any combination of the first 3 embodiments, wherein the filter media has a ratio of a maximum pore size to a mean flow pore size of about 2.5 or less.

A 5^{th} embodiment is any combination of the first 4 embodiments, wherein the wet-laid fibers have a basis weight of at least about 50 gsm.

A 6^{th} embodiment is any combination of the first 5 embodiments, wherein the basis weight is about 50 gsm to about 200 gsm.

A 7^{th} embodiment is any combination of the first 6 embodiments, wherein the basis weight is about 100 gsm.

An 8^{th} embodiment is any combination of the first 7 embodiments, wherein the wet-laid fibers are foam-laid fibers.

A 9^{th} embodiment is any combination of the first 8 embodiments, wherein the wet-laid fibers comprise a material selected from the group consisting of polypropylene, polyester, polypropylene, co-polyamides, polyethylene, polycarbonate, polyacrylate, polyacrylonitrile, polystyrene, styrene maleic anhydride, propylene, polyimide, polyether ketone, cellulose ester, nylon and polyamide, acrylic, vinyl acetate, ethylene vinyl acetate, styrene-butadiene, ethylene/vinyl chloride, vinyl acetate copolymer, latex, epoxy, polyurethane, cellulose, styrene and combinations thereof.

A 10^{th} embodiment is any combination of the first 9 embodiments, wherein the wet-laid fibers comprise polyester.

An 11^{th} embodiment is any combination of the first 10 embodiments, wherein the melt blown fibers comprises polyester.

A 12^{th} embodiment is any combination of the first 11 embodiments, wherein the support structure comprises a netting comprising strands.

A 13^{th} embodiment is any combination of the first 12 embodiments, wherein the strands have a basis weight of at least about 100 gsm

A 14^{th} embodiment is any combination of the first 13 embodiments, wherein the basis weight is at least about 110 gsm.

A 15^{th} embodiment is any combination of the first 14 embodiments, wherein the support structure is ultrasonically bonded to the first layer at a plurality of attachment points.

A 16^{th} embodiment is any combination of the first 15 embodiments, wherein the netting comprises a material selected from the group consisting of high-density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

A 17^{th} embodiment is any combination of the first 16 embodiments, wherein the porosity of the first layer is about 90% to about 95%.

In another aspect, a liquid filter media is provided comprising the filter media of any combination of the first 17 embodiments.

1. A composite material for use as a filter media, the composite material comprising:
a layer comprising wet-laid fibers and melt blown fibers; and
wherein the layer has a ratio of a maximum pore size to a mean flow pore size of about 2.5 or less.

2. The composite material of claim 1, wherein the maximum pore size is less than about 30 microns.

3. The composite material of claim 1, wherein the wet-laid fibers and the melt blown fibers are calendared and the maximum pore size is less than about 13 microns.

4. The composite material of claim 1, wherein the mean flow pore size is less than about 15 microns.

5. The composite material of claim 1, wherein the wet-laid fibers and the melt blown fibers are calendared and the mean flow pore size is less than about 7 microns.

6. The composite material of claim 1, wherein the material has a bubble point of less than or equal to about 20 in/H²O and a dust holding capacity of at least about 24 mg/in².

7. The composite material of claim 1, wherein the material has an efficiency at capturing particles having a maximum dimension of about 25 microns of at least about 95.4% and a 95% or greater efficiency at capturing particles having a maximum dimension of 17 microns or greater.

8. The composite material of claim 1, wherein the material has an air permeability of about 66 cfm/ft²/min or less.

9. The composite material of claim 1, wherein the wet-laid fibers have a basis weight of at least about 50 gsm and the melt blown fibers have a basis weight of about 20 gsm to about 100 gsm.

10. The composite material of claim 1, wherein the wet-laid fibers are foam-laid fibers.

11. A liquid filter media comprising the composite material of claim 1.

12. A filter media comprising:
a first layer comprising wet-laid fibers and melt blown fibers; and
a support structure in contact with the first layer.

13. The filter media of claim 12, wherein the filter media has a maximum pore size of less than about 30 microns.

14. The filter media of claim 12, wherein the wet-laid fibers and the melt blown fibers are calendared and the maximum pore size is less than about 13 microns.

15. The filter media of claim 12, wherein the filter media has a mean flow pore size of less than about 15 microns.

16. The filter media of claim 12, wherein the wet-laid fibers and the melt blown fibers are calendared and the mean flow pore size is less than about 7 microns.

17. The filter media of claim 12, wherein the filter media has a ratio of a maximum pore size to a mean flow pore size of about 2.5 or less.

18. The filter media of claim 12, wherein the support structure comprises a netting comprising strands and the strands have a basis weight of at least about 100 gsm.

19. The filter media of claim 18, wherein the support structure is ultrasonically bonded to the first layer at a plurality of attachment points.

20. The filter media of claim 12, wherein the first layer has a porosity of about 90% to about 95%.
